(19) United States
(12) Patent Application Publication
(10) Pub. No.: US 2004/0065400 A1
(43) Pub. Date: Apr. 8, 2004

(54) Stitched yarn surface structure and method of forming the same

(76) Inventors: Dimitri Peter Zafiroglu, Wilmington, DE (US); Richard James Celeste, Newark, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/681,297

(22) Filed: Oct. 6, 2003

Related U.S. Application Data
(62) Division of application No. 09/564,874, filed on May 4, 2000.

(51) Int. Cl. B32B 5/00

(52) U.S. Cl. 156/72

(57) ABSTRACT

A stitched yarn surface structure comprises a backing the entire upper surface of which is covered by a plurality of rows of face yarn underlaps. The face yarn underlaps may be stitched-into the backing, or held to the backing by longitudinally extending overstitches. The yarn underlaps form a yarn surface having a height dimension D. The backing has a thickness dimension T that is at least twice the height dimension D and not less than two millimeters.

### BACKGROUND OF THE INVENTION

1. Field of the Invention

The present invention relates to a floor covering, and in particular to a stitched yarn surface structure having face yarn underlaps that cover the entire first surface of a backing.

2. Description of the Prior Art

Pile structures prepared by tufting, weaving or knitting are commonly used to cover floors and/or walls in situations where high durability and a degree of insulation and cushioning are required. Such pile structures are exemplified by carpets, velours, knit or woven velvets, and needlepunched products. The surfaces of these pile structures are open between the face fibers, allowing the easy penetration of dirt, dust and various microorganisms into the body of the structure. Coverings such as vinyl or hardwood, on the other hand, do not allow penetration and are easier to clean, but lack the cushioning and insulation effects offered by the fibrous pile structures. Fabrics laminated to cushioned underlays also offer a degree of resistance to penetration, and potentially better cleanability. However, laminated structures are subject to edge-fraying, delamination, and dimensional distortions, the latter probably due to the difficulty in matching the expansion and contraction of the face fabrics and the sublayers as temperature and humidity change.

In view of the foregoing it is believed that a pile surface structure having a tightly-filled fibrous surface coupled with a cushioning layer, eliminates the various problems presented by the pile structures, hard coverings, and laminates of the prior art.

### SUMMARY OF THE INVENTION

The present invention is directed to a stitched yarn surface structure and a method of forming the same. The stitched yarn surface structure comprises a backing, the entire upper surface of which is covered by a plurality of rows of face yarn underlaps. The face yarn underlaps may be stitched-into the backing, or held to the backing by longitudinally extending overstitches. The yarn underlaps form a yarn surface having a height dimension D. The backing has a thickness dimension T that is at least twice the height dimension D and not less than two millimeters.

The backing may be implemented as a two-layer structure, wherein one layer is formed from a cushioning material that is disposed next-adjacent to the yarn underlaps. A sheet of binder or moisture blocking material may be disposed over the upper surface of the backing. The sheet of moisture blocking material may alternatively be disposed over the lower surface of the backing.

One or more strand(s) of binder material may be disposed adjacent the upper surface of the backing. Alternatively, or additionally, one or more strand(s) of reinforcing material may be disposed adjacent the upper and/or lower surface of the backing. By varying the tension by which the underlaps are held to the backing a quilted effect may be imparted to the yarn surface.

The yarn layer covers the entire surface and is capable of expansion and contraction between stitches without distorting the product and is not susceptible to edge-fraying.

### BRIEF DESCRIPTION OF THE DRAWINGS

The invention will be more fully understood from the following detailed description, taken in connection with the accompanying drawings, which form a part of this application and in which:

FIGS. 1A and 1B are side and front elevational views, respectively, of a laid-in stitched yarn surface structure in accordance with a first embodiment of the present invention, with FIG. 1A illustrating a first form of backing while FIG. 1B illustrates an alternative form of backing;

FIG. 2 is a front elevational view of a laid-in stitched yarn surface structure in accordance with the first embodiment of the present invention as modified to include at least one layer of longitudinally and/or transversely extending strands of binder material;

FIG. 3A is a front elevational view of a laid-in stitched yarn surface structure in accordance with the first embodiment of the present invention as modified to include at least one layer of longitudinally extending strands of reinforcing material while FIG. 3B is a front elevational view of the laid-in stitched yarn surface structure as modified to include at least one layer of transversely extending strands of reinforcing material;

FIG. 4A is a front elevational view of a laid-in stitched yarn surface structure in accordance with the first embodiment of the present invention alternately modified to include a sheet of binder or moisture-blocking material respectively on the upper or the lower surface thereof;

FIG. 4B is a front elevational view of a laid-in stitched yarn surface structure in accordance with the first embodiment of the present invention further alternately modified to include a surface fixative material on the laid-in underlaps and a coating of a liquid binder material on the upper surface thereof and a coating of a moisture-blocking material on the lower surface thereof;

FIGS. 5A and 5B are front elevational views illustrating a transverse cross section of the laid-in stitched yarn surface structure in accordance with the first embodiment of the present invention yet further alternately modified to exhibit “quilted” surface effects;

FIG. 5C is a side elevational view illustrating a longitudinally extending line of overstitches of the laid-in stitched yarn surface structure in accordance with the first embodiment of the present invention even further alternately modified to exhibit another “quilted” surface effect;

FIGS. 6A and 6B are side and front elevational views, respectively, of a stitched-in yarn surface structure in accordance with a second embodiment of the present invention;

FIG. 7 is a front elevational view of a stitched-in yarn surface structure in accordance with the second embodiment of the present invention alternately modified to include either a sheet of binder material or moisture-blocking material and/or to include a layer of reinforcing strands;

FIG. 8 is a front elevational view illustrating a transverse cross section of the stitched-in yarn surface structure in accordance with the second embodiment of the present invention yet further alternately modified to exhibit a “quilted” surface effect;

FIG. 9 is a diagrammatic illustration of an overall system including a stitching apparatus for forming a stitched yarn surface structure in accordance with either embodiment of the present invention;

FIG. 10 is a stylized perspective view of a stitching apparatus for forming a laid-in stitched yarn surface structure in accordance with the first embodiment of the present invention; and

FIG. 11 is a stylized perspective view of a stitching apparatus for forming a stitched-in yarn surface structure in accordance with the second embodiment of the present invention.

### DESCRIPTION OF PREFERRED EMBODIMENT

Throughout the following detailed description similar reference numerals refer to similar elements in all figures of the drawings.

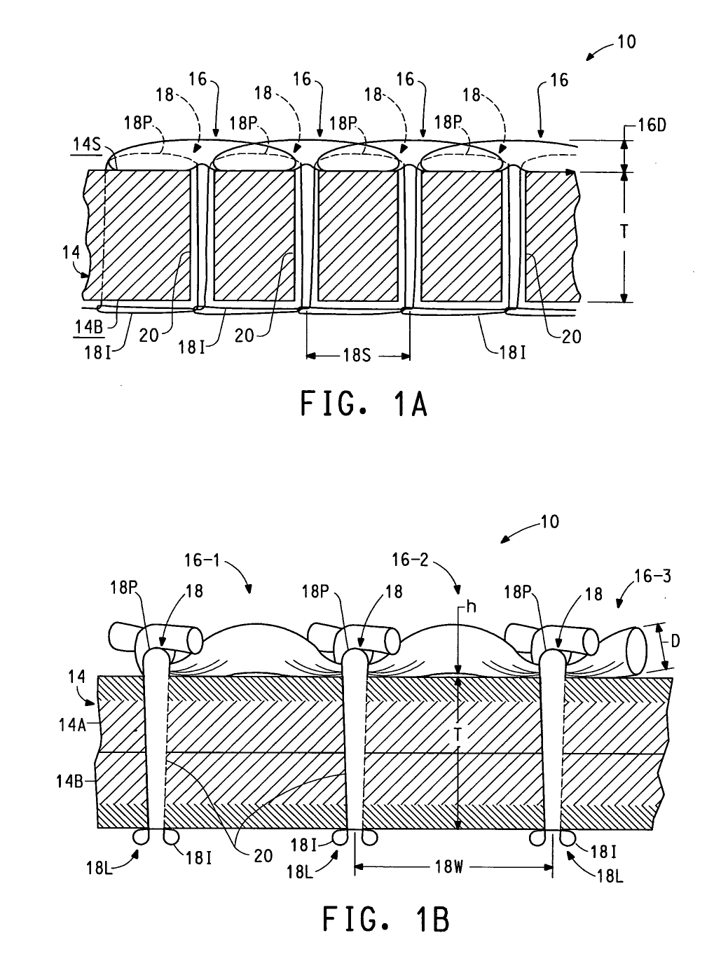

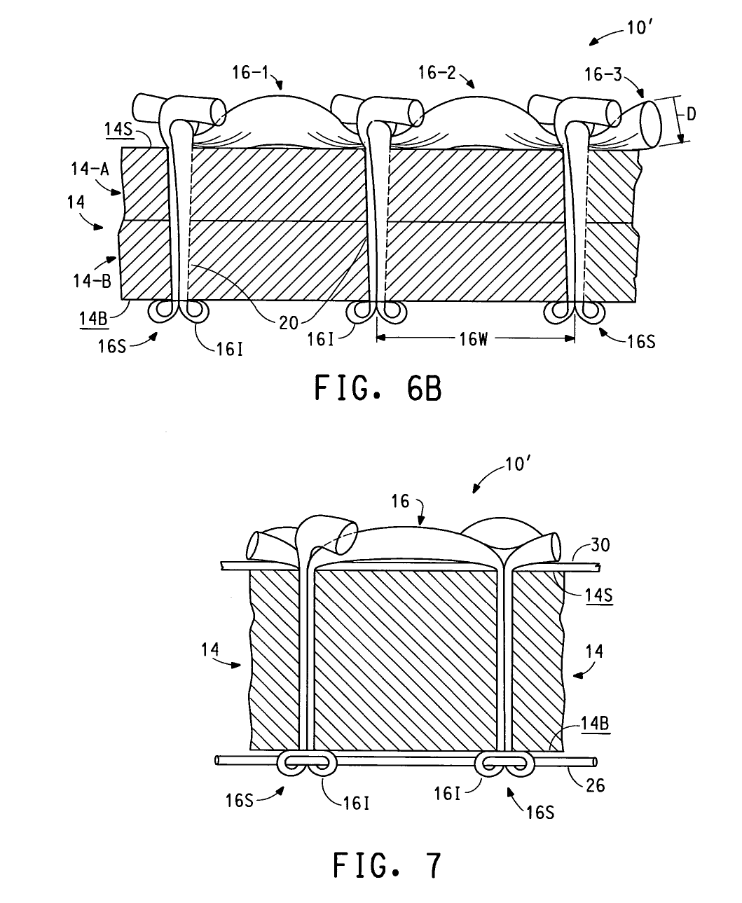

The stitched yarn surface structure in accordance with the present invention may be implemented in either a laid-in or a stitched-in embodiment. The laid-in embodiment of the present invention is illustrated in detail in FIGS. 1A through 5C, while the stitched-in embodiment of the present invention is illustrated in FIGS. 6A through 8.

Referring first to FIGS. 1A and 1B, shown are side and front elevational views, respectively, of the basic arrangement of a laid-in stitched yarn surface structure generally indicated by the reference character 10 in accordance with a first embodiment of the present invention. Various modifications to the basic implementation of the first embodiment shown in FIG. 1A are illustrated in FIGS. 1B through 5C. It should be understood that any combinations of these various modifications may be utilized as desired and remain within the contemplation of the present invention.

As seen in FIGS. 1A and 1B the stitched yarn surface structure 10 includes a backing 14 having a first, upper, surface indicated by the reference character 14S and a second, lower, surface indicated by the reference character 14B. A plurality of rows 16-1, 16-2, 16-3 (FIG. 1B) of face yarn underlaps 16 cooperate to form a yarn surface that covers substantially the entire upper surface 14S of the backing 14. The yarn used to form the underlaps 16 has a diametric dimension indicated by the reference character D (FIG. 1B). When laid onto the surface 14S the height dimension 16D of the yarn surface is slightly larger than the yarn diameter. The slight discrepancy between the yarn diameter D and the height dimension 16D is due to the slight clearance distance “h” (FIG. 1B) defined during the laying-in of the underlaps 16.

The yarn forming the yarn surface in either embodiment of the invention may be made from any natural or synthetic fiber, and may be in the continuous filament or spun-staple form. Most commonly, the yarn material is nylon, polyester or polypropylene. Bi-component yarns used in carpets and upholstery may also be utilized.

In the laid-in version of the stitched yarn surface structure shown in FIGS. 1A and 1B the face yarn underlaps 16 are held to the upper surface 14S of the backing 14 by overstitches generally indicated by the reference character 18. The overstitches 18 are arranged into a plurality of parallel lines 18L (FIG. 1B). Each line 18L of overstitches 18 extends longitudinally along the backing 14. The spacing between transversely adjacent lines 18L of overstitches is termed the “wale” and is indicated by the reference character 18W (FIG. 1B).

Each overstitch 18 includes a lap portion 18P that secures a face yarn underlap 16 against the first surface 14S of the backing 14. Each overstitch 18 also includes an interlockable loop portion 18I that lies against the bottom surface 14B of the backing 14. As best seen in FIG. 1A the lap portion 18P of each overstitch 18 extends from the upper surface 14S through needle penetration points 20 formed through the backing 14. Adjacent the undersurface 14B of the backing 14 each lap portion 18P interlocks, chain fashion, to the loop portion 18I of an adjacent overstitch 18 in the same longitudinal line 18L. The longitudinal spacing between needle penetration points 20 is termed the “stitch length” and is indicated by the reference character 18S.

Any suitable thread may be used to form the overstitches 18. In a preferred instance the overstitches 18 may be formed from a stitching thread comprising a composite of a low-melting temperature binder material and a higher melting temperature material. The two components of the composite stitching thread may be combined by twisting, air-entangling, or other processes.

The backing 14 used in either embodiment of the invention is made of a material that is easily penetrable by needles and yet has sufficient cohesion to withstand the stitching operation to be described and sufficient resilience to avoid collapse. The backing should have sufficient strength such that if used without reinforcement it is able to hold stitches. However, if reinforced as described, the strength required from the backing is diminished, since structural stability for the yarn surface structure 10 (FIGS. 1A-5C), 10′ (FIGS. 6A-8) is provided by the overstitches and the reinforcing strands to be described.

In its basic implementation the backing 14 used in both embodiments of the invention has a uniform thickness dimension T. As seen in FIG. 1B the thickness dimension T of the backing 14 is measured between the top surface 14S and the bottom surface 14B at a point substantially transversely midway along an underlap 16 (that is, at a point substantially midway between transversely adjacent stitch lines 18L). In accordance with the present invention the thickness dimension T is at least twice the height dimension 16D of the yarn surface, but is not less than two millimeters.

The backing 14 may be implemented using a polymeric foam sheet, felt, a corrugated composite material, or a composite of bonded composite of foam and fibers, such as reclaimed waste from carpets. The backing 14 could be formed as a single integral layer as is illustrated in FIG. 1A. Alternatively, as is illustrated in FIG. 1B, the backing 14 may comprise at least two layers 14A, 14B of dissimilar materials. If implemented in a layered structure at least one of the layers 14A, 14B of the backing 14 is made of a soft, cushioning material. Preferably, the layer 14A of the soft, cushioning material is disposed adjacent to the underlaps 16.

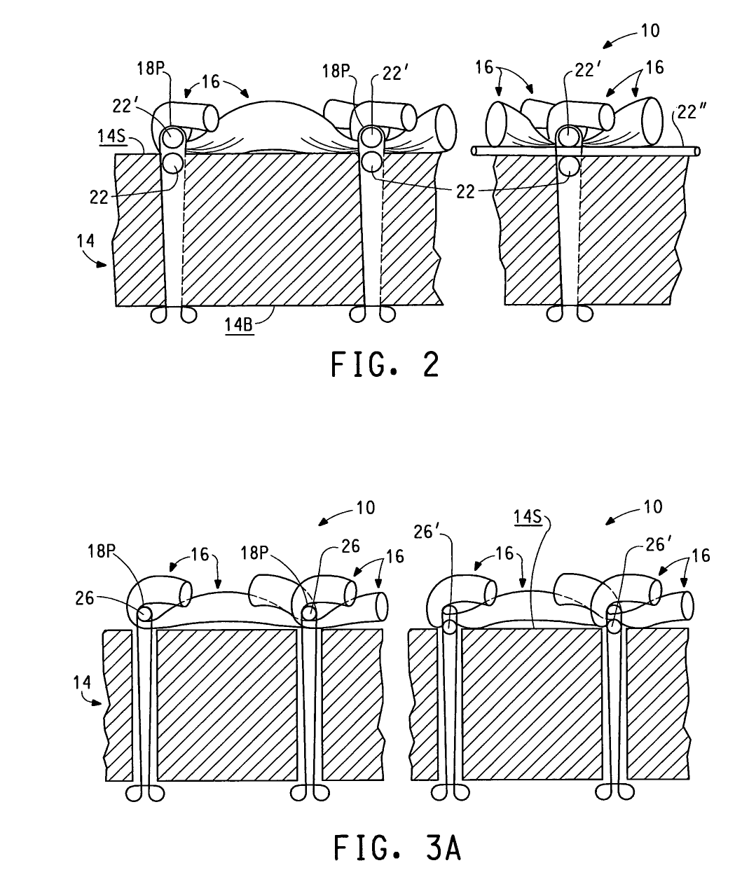

FIG. 2 illustrates another modification to the basic arrangement of the laid-in yarn surface structure shown in FIGS. 1A, 1B. In accordance with this modification a plurality of strands of binder material are arranged to form at least one layer of strands disposed over the first surface 14S of the backing 14. The strands in the layer may be formed of a low melting temperature binder material such as a low melting copolymer of nylon, polyester or polyolefin. The binder strands may extend longitudinally along the backing 14 or may extend transversely across the backing 14.

As is best illustrated in the left hand portion of FIG. 2, if a single longitudinally extending layer of binder strands is used each binder strand 22 is preferably located between the yarn underlaps 16 and the first surface 14S of the backing 14. Alternatively, each binder strand 22′ in a single longitudinally extending layer may be located between above the yarn underlaps 16, where it is there held by the laps 18P of the overstitches 18.

If a single transversely extending layer of binder strands is used, each binder strand 22″ in such a layer is located between the yarn underlaps 16 and the first surface 14S of the backing 14. This arrangement is illustrated in the right hand portion of FIG. 2. Such a layer of strands 22″ can be placed using a weft insertion technique.

It lies within the contemplation of the present invention to dispose a second layer of binder strands to be used in conjunction with the first layer of binder strands. If a second layer of strands is used the strands in the second layer may be located in any of the above-noted positions complementary to a first layer of binder strands 22. Thus, for example, if the first layer of strands 22 were used (between the yarn underlaps 16 and the first surface 14S), a second layer of strands 22′ (held above the yarn underlaps 16 by the laps 18P) may also be utilized. As shown in the right hand portion of FIG. 2, one or more layer(s) of longitudinally extending strands (e.g., strands 22 and/or 22′) may be used with a layer of transversely extending strands 22″.

FIGS. 3A and 3B illustrate yet another modification to the basic arrangement of the laid-in yarn surface structure shown in FIGS. 1A, 1B. In accordance with this modification at least one layer of strands of reinforcing material is disposed over the first surface 14S of the backing 14. The reinforcing strands can be made from a higher melting temperature and higher tenacity nylon, polyester, glass, or polyimide material.

A single layer of reinforcing strands 26 may extend longitudinally between the lap portion 18P of the overstitch 18 and the yarn underlap 16, as illustrated in the left-hand portion of FIG. 3A. Alternatively, the single layer of reinforcing strands 26′ may extend longitudinally between the lap portion 18P of the overstitch 18 and the first surface 14S of the backing 14, as illustrated in the right-hand portion of FIG. 3A. As yet another alternative, shown in the left-hand portion FIG. 3B the single layer of reinforcing strands 26″ may be extend transversely over the first surface 14S of the backing 14, at a location beneath the underlap 16.

As is the case with the binder strands one or more additional layers of longitudinally extending reinforcing strands may be located in any position complementary to a first layer of binder strands. Thus, for example, if a first layer of reinforcing strands 26 is disposed above the yarn underlap 16, a second layer of reinforcing strands 26′ may be disposed longitudinally under the yarn underlap 16 or transversely under the yarn underlap 16. Still further, if two layers of strands are used, yet a third layer of strand may be disposed at a complementary position on the first surface 14S of the backing 14.

As shown in the right-hand portion of FIG. 3B, a layer of reinforcing strands 26³ may alternatively or additionally be disposed adjacent to the lower surface 14B of the backing 14. When used against the lower surface 14B the layer of reinforcing strands 26³ extends transversely.

In sum, it lies within the contemplation of the present invention to utilize one or more longitudinal and/or transverse strands of either binder and/or reinforcing material disposed in any of the locations shown or described in connection with FIGS. 2, 3A and 3B.

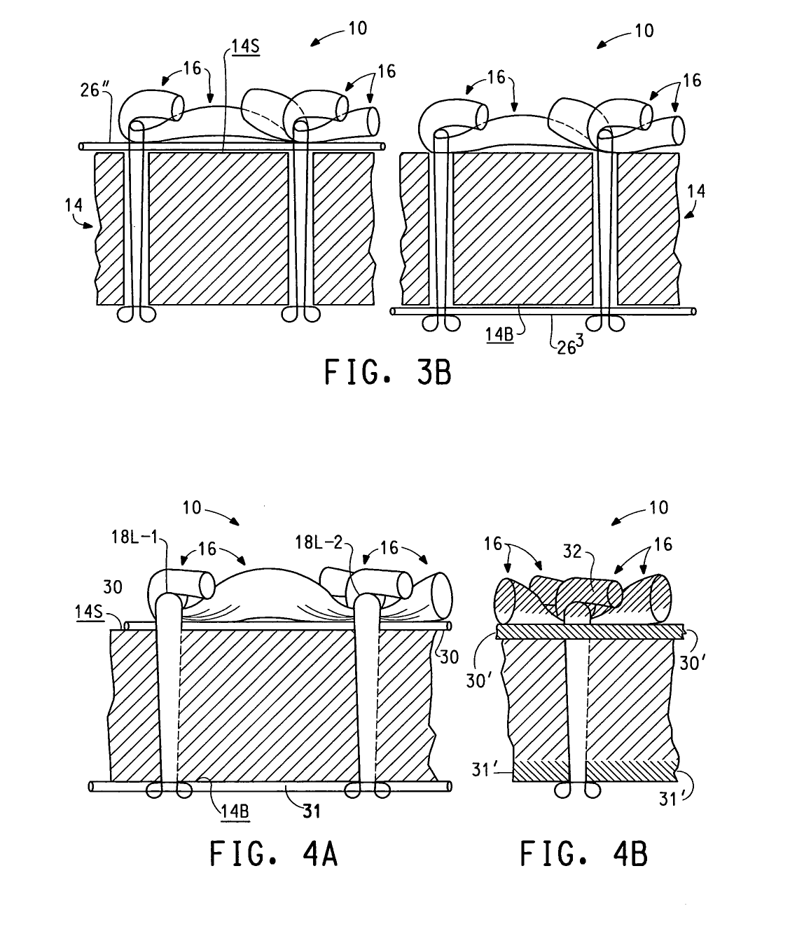

Various alternative modifications to the first embodiment of the yarn surface structure 10 are shown in FIGS. 4A and 4B. In accordance with this modification the stitched yarn surface structure further includes a sheet 30 (FIG. 4A) of a low melting temperature binder material disposed between the yarn underlaps 16 and the first surface 14S of the backing. The sheet 30 of binder material may be added onto the upper surface 14B before stitching. Alternatively, as shown in FIG. 4B, the binder material may be applied as a liquid coating 30′ to the upper surface 14S of the backing 14. Whether applied in the form of a sheet 30 or as a liquid coating 30′, when activated the binder material secures the underlaps 16 to the upper surface 14S of the backing 14.

As yet a further alternative, the yarn surface structure 10 may include a sheet 31 of a moisture blocking material, such as a film membrane or a coated nonwoven or woven, made from polypropylene or polyester. The sheet 31 of moisture blocking material is preferably disposed adjacent to the lower surface 14B of the backing 14 (as is illustrated in FIG. 4A). The sheet 31 of moisture blocking material may be added onto the lower surface 14B before stitching or as a layer of a multi-layer backing structure. As yet a further alternative, the moisture blocking material may take the form of a liquid coating 31′ applied to the lower surface 14B. When cured the moisture blocking material 31′ forms a liquid impenetrable layer over the surface to which it is applied.

FIG. 4B also illustrates another alternative modification to the first embodiment of the present invention. The underlaps 16 may have a layer of a fixative material 32 applied as a liquid onto the top surface thereof. When cured the fixative material forms a flexible layer over the underlaps 16 and imparts durability and pilling resistance thereto. Flexible resin materials as a such as polyurethanes, soft acrylics may be used as the fixative material.

If a sheet 30, 31 or coating 30′, 31′, whether made of a binder material or a moisture blocking material, must be penetrable by the needles used to form the yarn surface structure 10 (or 10′).

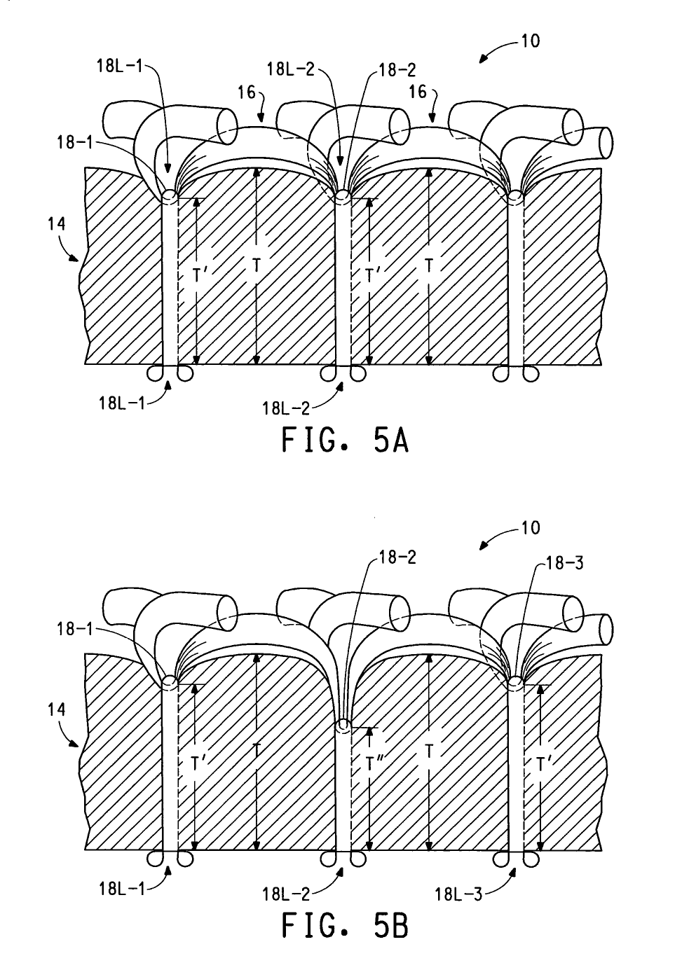

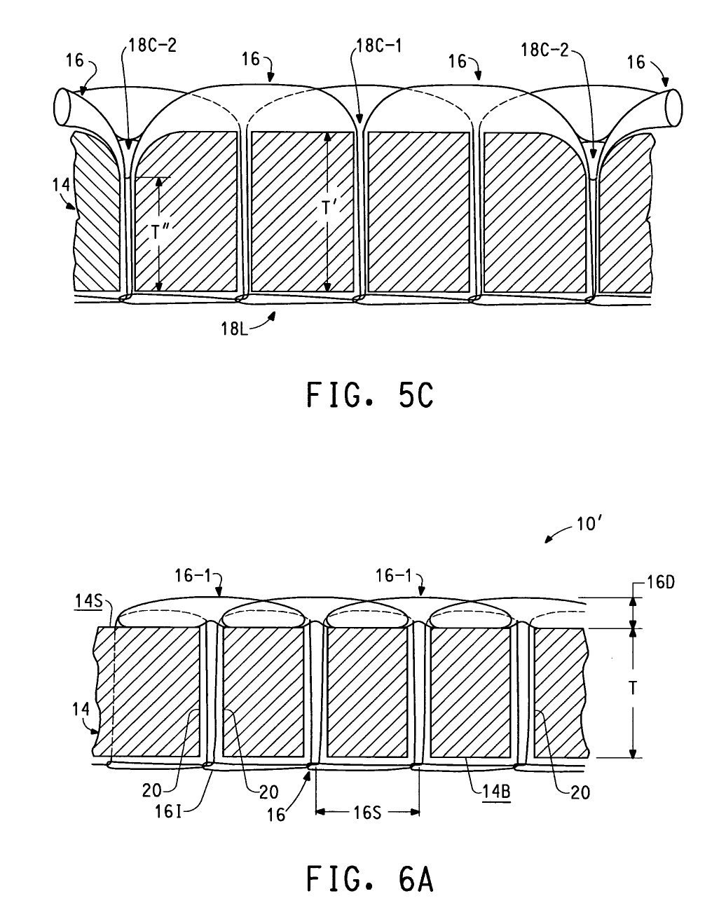

FIGS. 5A through 5C illustrate yet other alternative modifications to the first embodiment of the yarn surface structure 10. Generally speaking, in accordance with these alternative modifications the overstitching threads 18 have been tightened such that the backing 14 in the vicinity of the laps 18P of the overstitches 18 exhibits a thickness dimension that is less than the thickness dimension of the backing 14 substantially intermediate between transversely adjacent lines of stitches. The thickness dimension may be varied longitudinally and/or transversely across the backing to impart an undulating configuration to the yarn surface structure. Tightening of the overstitching threads to compress the backing in the vicinity of the laps imparts a quilted, or corrugated, surface to the yarn surface structure.

As a first alternative, illustrated in the transverse cross section of the yarn surface structure of FIG. 5A, the overstitching threads 18 have been tightened such that the thickness dimension T of the backing 14 measured at a point substantially transversely midway between a pair of overstitches 18-1, 18-2 in transversely adjacent lines 18L-1, 18L-2 of overstitches is greater than the thickness dimension T′ of the backing 14 in the vicinity of each of the pair of overstitches 18-1, 18-2. Preferably, the thickness dimension T should be at least ten percent (10%) greater than the thickness dimension T′. More preferably, the thickness dimension T should be at least twenty to fifty percent (20-50%) greater than the thickness dimension T′. The thickness dimension T′ is measured between the top surface 14S and the bottom surface 14B at the location above-described and indicated in the Figure.

This modification imparts a uniformly quilted surface texture to the yarn surface structure, similar to the texture of a corduroy fabric.

A second alternative modification is illustrated in the transverse cross section of the yarn surface structure shown in FIG. 5B. In this instance the overstitching threads 18 have been tightened such that thickness of the backing varies transversely. The basic thickness dimension T of the backing 14 is again measured at a point substantially transversely midway between a pair of overstitches 18-1, 18-2 in transversely adjacent stitch lines 18L-1, 18L-2 or between a pair of overstitches 18-2, 18-3 in transversely adjacent stitch lines 18L-2, 18L-3. As seen, the thickness dimension T is greater than the thickness dimension T′ of the backing 14 measured between the top surface 14S and the bottom surface 14B in the vicinity of overstitch 18-1 (and overstitch 18-3). As is also illustrated the thickness dimension T is greater than the thickness dimension T″ measured between the top surface 14S and the bottom surface 14B of the backing 14 in the vicinity of overstitch 18-2 (paired with the overstitches 18-1, 18-3). Again, the thickness dimension T is at least ten percent (10%), and most preferably twenty to fifty percent (20-50%), greater than either thickness dimensions T′, T″.

In addition, in the implementation illustrated in FIG. 5B the thickness dimension of the backing in the vicinity of each overstitch in a transversely adjacent pair of overstitches is varied. More particularly, the thickness dimension T′ in the vicinity of the overstitches 18-1 or 18-3 varies by at least ten percent (10%) from the thickness dimension T″ in the vicinity of its paired overstitch 18-2. The thickness dimensions T′, T″ should vary by at least ten percent (10%), and most preferably twenty to fifty percent (20-50%) between the paired overstitches.

This modification imparts a transversely varying quilted surface texture to the yarn surface structure, similar to the texture of a randomly or pattern-quilted surface.

A third alternative modification is illustrated in the longitudinal section of the yarn surface structure shown in FIG. 5C. In this implementation the overstitching thread 18 forming a given longitudinally extending line of overstitches 18L has been alternately tightened and loosened such that thickness of the backing 14 varies longitudinally from course to course. In this modification the thickness dimension T′ of the backing in the vicinity of a first course 18C-1 in the longitudinal line of overstitches 18L varies by at least ten percent (10%) from the thickness dimension T″ the vicinity of a second course 18C-2 in the same longitudinal line 18L of overstitches. The thickness dimensions T′, T″ should vary by at least ten percent (10%), and most preferably twenty to fifty percent (20-50%). The various thickness dimensions T′, T″ are measured between the top surface 14S and the bottom surface 14B at the locations indicated.

The modification shown in FIG. 5C imparts a longitudinally varying quilted surface texture to the yarn surface structure, similar to the texture of a nonlinear two-dimensionally varied quilt.

It should also be noted that although thickness dimensions are indicated by similar reference characters T, T′, and T″ from FIG. 5A to FIG. 5C, this is not be taken to imply that the absolute magnitudes of the various dimensions in these Figure are necessarily numerically equal.

-o-0-o

FIGS. 6A and 6B are respective side and front elevational views of a stitched-in yarn surface structure generally indicated by the reference character 10′ in accordance with a second embodiment of the present invention. Various modifications to the structure of the second embodiment are illustrated in FIGS. 6B, 7 and 8. Any combination of these various modifications may be utilized as desired and remain within the contemplation of the present invention.

A plurality of rows 16-1, 16-2, 16-3 (FIG. 6A) of face yarn underlaps 16 are formed and cooperate to define a yarn surface that covers substantially the entire upper surface 14S of the backing 14. When stitched into backing 14 the yarn surface has a height dimension 16D above the surface 14S of the backing 14.

The primary difference between the first and second embodiment of the invention is that in the case of the stitched-in embodiment illustrated in FIGS. 6A through 8 the yarn underlaps 16 are stitched into the backing 14 without the use of an overstitching thread. The yarns forming the underlaps 16 are drawn through the needle insertion points 20 to form stitches 16S. The yarns 16 interlock with each other adjacent to the bottom surface 14B of the backing 14, as shown at 16I. The spacing, or “wale”, between transversely adjacent lines of stitches 16S is indicated by the reference character 16W (FIG. 6B). The longitudinal spacing between needle penetration points 20 (“stitch length”) is indicated by the reference character 16S.

In the basic instance the backing 14 exhibits a uniform thickness dimension T measured between the top surface 14S and the bottom surface 14B at a point substantially transversely midway along an underlap 16 (that is, at a point substantially midway between transversely adjacent lines of stitches 16S). In accordance with the present invention the thickness dimension T is at least twice the height dimension 16D of the yarn surface, but is not less than two millimeters.

The backing 14 could be formed as a single integral layer as is illustrated in FIG. 6A, or as illustrated in FIG. 6B, may comprise at least two layers 14A, 14B of dissimilar materials. At least one of the layers 14A, 14B of the backing 14 is made of a soft, cushioning material. Preferably, the layer 14A of the soft, cushioning material is disposed adjacent to the yarn underlaps 16.

FIG. 7 illustrates a modification to the basic arrangement of the stitched-in yarn surface structure 10′ shown in FIGS. 6A, 6B. In this modification a layer of strands 26 of reinforcing material extends transversely over the bottom surface 14B of the backing 14. The reinforcing strands 26 can be made from a higher melting temperature and higher tenacity nylon, polyester, glass, or polyimide material. The reinforcing strands 26 are held against the bottom surface 14B by the interlocking portions 16I of the stitches 16S.

FIG. 7 also illustrates the modification in which the stitched yarn surface structure 10′ further includes a sheet 30 of binder material disposed between the yarn underlaps 16 and the first surface 14S of the backing 14.

The sheet 30 of binder material may be added onto the lower surface 14B during stitching. Alternatively, the sheet 30 may be integrated into the backing 14 to form one layer of a multi-layer backing structure, as discussed earlier in connection with FIG. 1B. It should also be understood that the various alternative modifications discussed in connection with FIGS. 4A and 4B wherein the layer 30′ of binder material or the layer 31′ of moisture blocking material is applied in a liquid form may be used in connection with the stitched-in embodiment of the yarn surface structure 10′. In addition, a fixative material 32 may also be applied to the yarn underlaps, as is discussed in connection with FIG. 4B.

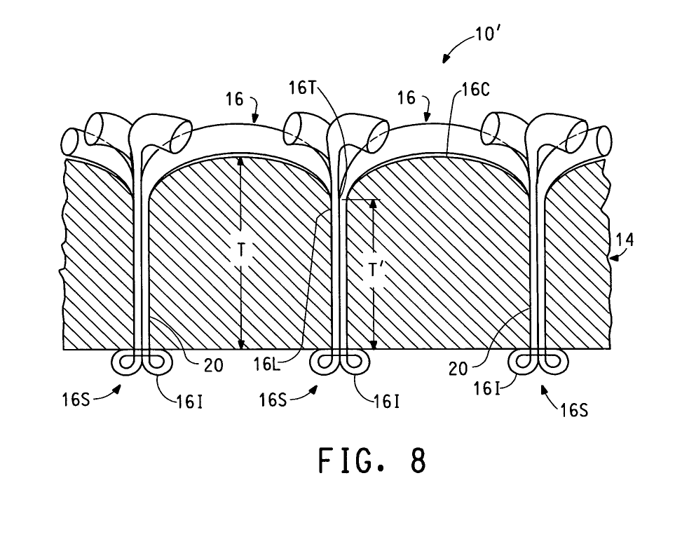

FIG. 8 is a transverse cross section of the yarn surface structure illustrating a further modification in which a quilted, or corrugated, surface is imparted to the yarn surface structure 10′. The stitches 16S are tightened such the thickness dimension T of the backing 14 at a point substantially midway between a pair of stitches 16S in transversely adjacent lines of stitches is at least ten percent (10%) greater than the thickness dimension T′ of the backing 14 in the vicinity of each of the pair of stitches 16S.

The thickness T′ of the backing 14 is measured between the bottom surface 14B and a transition point 16T in the underlap 16. The transition point 16T is that point at which the generally linear stitch portions 16L of transversely adjacent stitches contact each other as the yarn forming the underlap 16 is drawn into the needle insertion points 20. This transition point 16T marks the demarcation point between the generally curved portion 16C of the underlap that overlies the first surface 14S and the linear portions 16L of the underlap that form the interlocking portion 16I of the stitch 16S.

-o-0-o

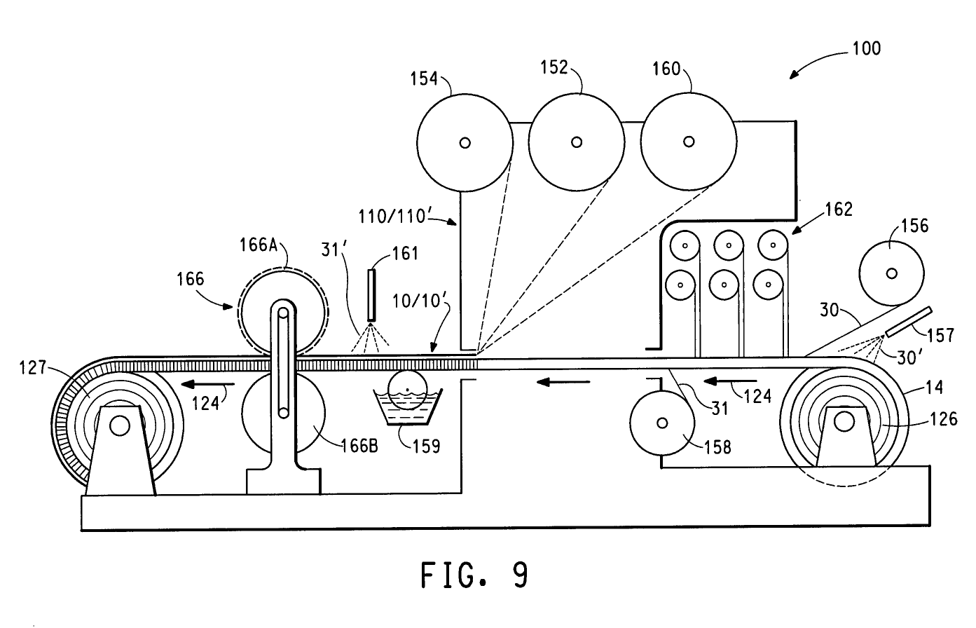

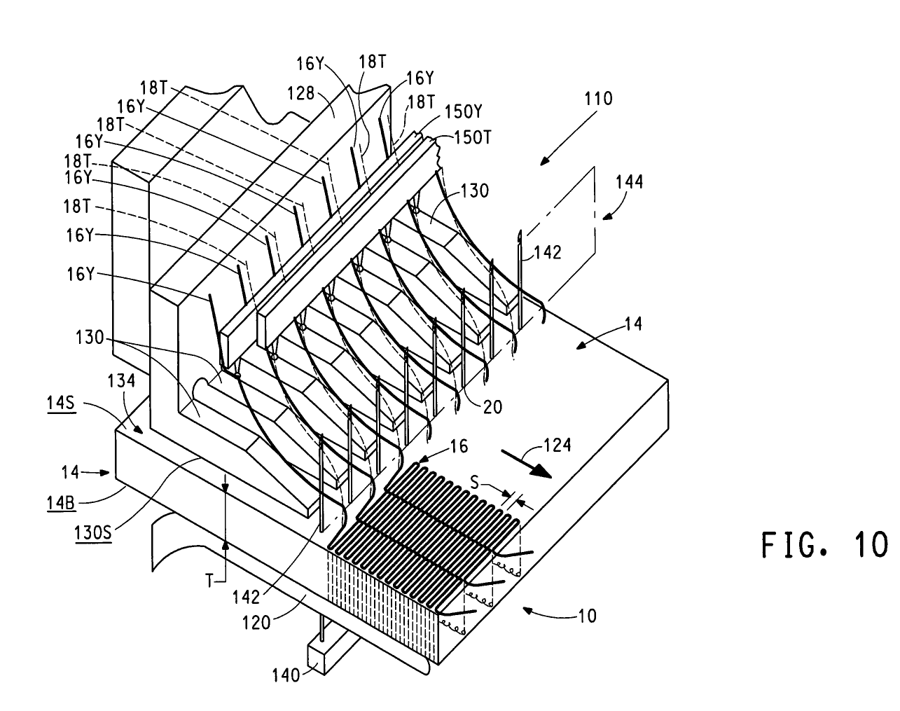

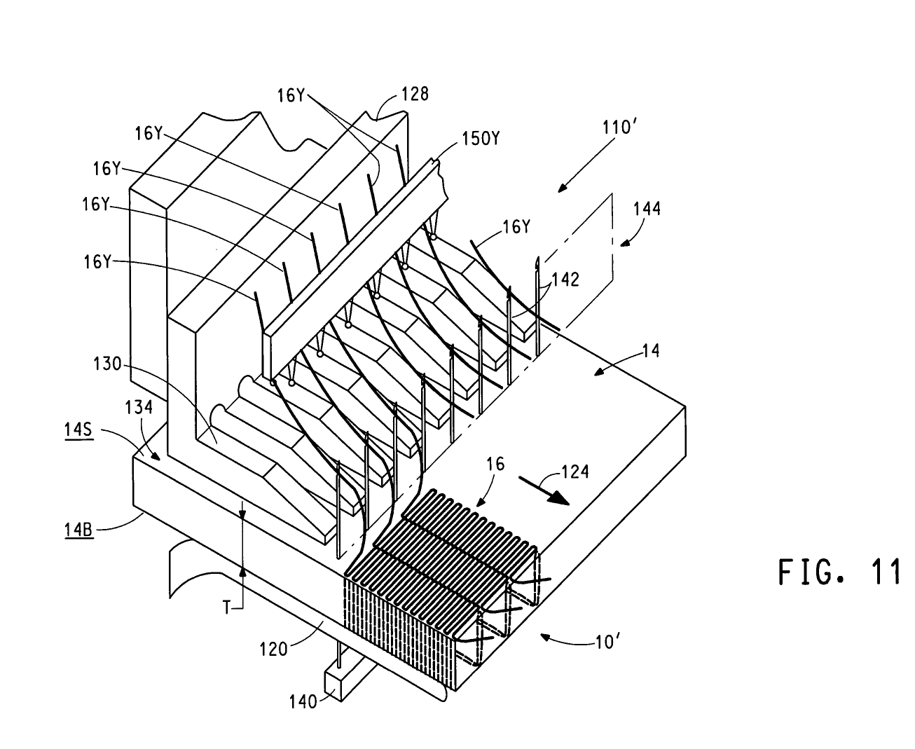

Shown in FIG. 9 is a diagrammatic illustration of a system generally indicated by the reference character 100 for forming the yarn surface structure 10/10′ in accordance with either the first, laid-in embodiment (FIGS. 1A through 5C) or the second, stitched-in embodiment (FIGS. 6A through 8) of the invention. The system shown in FIG. 9 includes a stitching apparatus generally indicated by the reference character 110 or 110′ and various supply and transport rolls appurtenant thereto. The yarn surface structure 10/10′ in accordance with the present invention is that structure emanating from the outlet of the stitching apparatus 110 or 110′, as the case may be. FIG. 10 is a more detailed view of a stitching apparatus 110 used for the laid-in embodiment of the yarn surface structure 10, while FIG. 11 shows a more detailed view of a stitching apparatus 110′ used for the stitched-in embodiment of the yarn surface structure 10′.

As is best seen in FIGS. 9 and 10 the stitching apparatus 110 includes a slotted platen 120 that supports a backing 14 along a generally planar path of travel extending longitudinally through the apparatus 110. The slots in the platen 120 are not visible in FIG. 10. The longitudinal direction of travel of the backing 14, also termed the “machine direction”, is indicated by the reference arrow 124. As used throughout this application the longitudinal direction of travel aligns with the longitudinal (or “warp”) direction of a yarn surface structure being produced, while the direction transverse to the warp direction is termed the “cross”, “transverse” or “weft” direction of the yarn surface structure being produced.

It is noted that the path of travel of the backing 14 through the apparatus 110 is arbitrarily shown in FIG. 10 as a horizontal path. The backing 14 is supplied to the platen 120 from a suitable supply roll 126 (FIG. 9). The backing 14 is conveyed incrementally in the machine direction 124 by a suitable propelling arrangement, such as a take-up roll 127 (FIG. 9).

At the inlet edge of the platen is a sinker bar 128 (FIG. 10). The sinker bar 128 extends transversely across the apparatus 110. A plurality of sinker fingers 130 extends forwardly from the sinker bar 128 in the machine direction 124. Each sinker finger 130 is spaced from a laterally adjacent finger 130 by a predetermined lateral spacing 132. The undersurface of each sinker finger 130 is indicated by the character 130S. The upper surface 120S of the platen 120 and the undersurface 130S of each sinker finger 130 cooperate to define a throat 134 into which the backing 14 is introduced into the apparatus 10.

A needle bar 140 having a plurality of penetrating needles 142 thereon is mounted beneath the platen 120. The needle bar 140 is spaced a predetermined distance forwardly of the ends of the sinker fingers 130. The needles 142 extend upwardly through the slots in the platen 120. The needle bar 140 is movable by a suitable actuator (not shown) such that the needles 142 are displaceable in vertically reciprocating fashion in a needle plane 144 located forwardly of the ends of the sinker fingers 130 and normal to the path of travel 124. Each of the reciprocating needles 142 intersects and penetrates the backing 14 at a respective needle penetration point 20. Each needle penetration point 20 is located in the transverse spacing 132 defined between laterally adjacent sinker fingers 130. The transversely extending line of needle penetration points 20 lies in the needle plane 144.

Guide bars 150T, 150Y are mounted above the sinker fingers 130 and above the planar path of travel of the backing 14 through the apparatus 110. Each guide bar 150T, 150Y has a plurality of downwardly depending guide elements. The guide elements may be implemented as circular eyelets, as illustrated, or may take the form of tubular members or wide spoon guides, if desired.

The guide elements on the guide bar 150Y serve to carry the yarns 16Y that are laid into the top surface 14S of the backing 14. Each yarn 16 is dispensed from a beam 152 (FIG. 9) and passes through a guide element on the yarn guide bar 150Y. The guide elements on the other guide bar 150T carry stitching threads 18T that form the stitches 18 that hold the yarns 16 to the backing 14. Each stitching thread T is dispensed from a separate beam 154 (FIG. 9).

Each guide bar 150Y, 150T is independently movable in various degrees of freedom by a suitable actuating arrangement (not shown). Typically, each guide bar 150Y, 150T may be swung transversely, forwardly, and/or backwardly with respect to any other guide bar. Thus, the yarns 16 and/or the threads 18T carried on the guide bars 150Y, 150T may be displaced with respect to the backing 14, and/or looped or interlocked with each other in a variety of fashions.

In operation, the backing 14 is introduced from the supply roll 126 into the throat 134 defined between the platen 120 and the sinker fingers 130. The bottom surface 14B of the backing 14 is supported on the platen 120 while the top surface 14S is presented to the undersurface 130S of the sinker fingers 130. The dimension 134T of the throat 134 is larger than the thickness dimension 14T of the backing 14, so that the backing 14 is relatively loosely confined between the sinker fingers 130 and the platen 120 as the backing 14 is advanced along its path of travel through the apparatus 110. If sheet(s) 30, 31 of binder and/or moisture blocking material, respectively, (FIGS. 4A, 4B) are to be included in the yarn surface structure 10, 10′ these elements are laid onto the top or bottom surface of the backing, as the cases may be, and advance with the backing through the apparatus 110, 110′. The sheets are dispensed to either surface of the backing 14 from appropriate supply rolls 156, 158.

If the binder material is applied in a liquid form as the layer 30′, a suitable dispenser 157, such as the sprayer, may be used to coat the material over the upper surface 14S. Similarly, if the moisture blocking material is applied in a liquid form as a layer 31′ to the bottom surface 14B, a suitable applicator 159, such as the roller or pad dispenser, may be disposed downstream of the stitching apparatus 110/110′.

If a layer 32 of fixative material is used, it may be applied to the underlaps using a suitable dispenser 161 (such as a sprayer, a pad applicator, a foam source or a doctor blade). The dispenser 161 is also located downstream of the stitching apparatus 110/110′.

Similarly, if longitudinal and/or transversely extending binder strands 22, 22′, 22″ (as the case may be) and/or reinforcing strands 26, 26′ and 26″ (again, as the case may be) are to be incorporated into the yarn surface structure these strands are dispensed from suitable beams or bobbins, as the case may be. If strand(s) is (are) longitudinally inserted a separate beam (e.g., the beam 161) and separate guide bar (not shown, but similar to the bars 150Y, 150T) is provided for each strand. If the strand(s) is (are) weft-inserted a separate bobbin (not shown) and a commercial weft insertion arrangement schematically indicated at 162 is used.

The backing 14 is conveyed along the path of travel so that successive transversely extending regions of the backing 14 are advanced into the needle plane 144. Before and after the yarn guide bar 150Y is transversely displaced to dispense the length of yarn 16Y that eventually forms the underlap 16 (FIGS. 1A, 1B) on the surface 14S of the backing 14 and stitching threads 18T from adjacent first and second thread guides on the thread guide bar 150T are successively looped around respective first and second locations on the dispensed length of yarn 16.

As successive transverse regions of the backing 14 move into the needle plane 144, adjacent needles are actuated and raised through the backing to positions above the path of travel. In the raised positions the adjacent needles respectively successively engage the looped first and the second stitching threads and draw these stitching threads downwardly toward the backing 14. These actions draw the length of dispensed yarn 16Y to the surface 14S of the backing 14, thereby forming a yarn underlap 16 that extends transversely and slightly diagonally over the first surface 14S of the backing 14. Continued downward movement of each needle through the backing 14 forms a lap portion 18P of an overstitch 18. The lap portion 18P (FIGS. 1A, 1B) of the overstitch 18 overlies the first surface 14S of the backing 14 and secures the yarn underlap 16 against that first surface 14S. Each stitch 18 also includes the interlockable looped overlap portion 18I that lies against the bottom surface 14B of the backing 14 as is best shown in the side elevational view of FIG. 1B.

For each successive longitudinal advance of a region of the backing 14 through the needle plane 144 each needle alternately cooperates with one of its laterally adjacent needles to form a yarn underlap 16 that extends across the top surface 14S of the backing 14.

In the terminology of the art this arrangement of underlaps 16 and stitching thread laps 18P may be identified as a reciprocating 0-0/2-2 stitch, or “tricot” stitch. “Laid Atlas” stitches such as 0-0/2-2/2-2/4-4/4-4/2-2/2-2/0-0, or longer laid stitches such as 0-0/3-3 or 0-0/4-4, may also be used.

The uniformly quilted product shown in FIG. 5A is produced by using a relatively soft and compressible backing 14 and a high tension on the stitches 18. Thus, the height T′ of the backing 14 in the vicinity of the stitches 18 is less than the height T substantially midway between transversely adjacent stitches. The transversely quilted product of FIG. 5B is formed by having a different tensions on transversely adjacent threads.

The longitudinally varying quilted product of FIG. 5C is formed by alternately raising and lowering the tension on the stitching thread 18T of various courses as needed to create the three-dimensional effect.

FIG. 11 shows a more detailed view of a stitching apparatus 110′ used for the stitched-in embodiment of the yarn surface structure 10′. Except for the distinctions to be noted the apparatus 110′ is substantially identical to the stitching apparatus 110 described in connection with FIG. 10. Accordingly, identical reference characters are used for identical structural elements; while modified elements or modified structural relationships will be indicated by single primed reference characters.

This primary difference between the apparatus 110 of FIG. 10 and the apparatus 110′ of FIG. 11 is the omission of the guide bar 150T and the beam 154 for an overstitching thread 18T (FIG. 10).

In operation, a given yarn 16Y is engaged by adjacent needles 142 to form yarn underlaps 16 that are stitched-into the backing 14. A basic tricot stitch, such as a 1-0/1-2 stitch across two stitch rows, is typically formed. “Combined Atlas” stitches such as 1-0/1-2/2-3/2-1 or 1-0/1-2/2-3/3-4/3-2/2-1 may also be used.

The yarn is drawn by the needles through the needle penetration points 20 to forms stitches 16S (FIGS. 6A, 6B). The stitches 16S interlock beneath the bottom surface 14B of the backing 14. A sheet 30, disposed either above or below the backing 14, is applied in the same manner as above discussed. Similarly, longitudinally and/or transversely extending binder and/or reinforcing strand(s) (if used) are supplied in the same manner as discussed earlier.

The quilted product of FIG. 8 (similar to the quilted product of FIG. 5A) is formed using a relatively soft and compressible backing 14 and having relatively high tension in the stitched-in yarns. Variations of tension from wale to wale and from course to course can also be utilized to produce effects similar to the products of FIGS. 5B and 5C.

As seen in FIG. 9, downstream of the stitching apparatus 110, 110′ a bonding apparatus 166, comprising a pair of heated finishing rolls 166A, 166B, is provided to heat-activate the binder material, if present in the yarn surface structure 10, 10′. When heat-activated the binder material (whether applied in the form of strands 22, 22′ and/or 22″, in the form of a sheet 30, or in the form of a layer 30′ of liquid coated onto the first surface) holds the face yarn underlaps to the first surface 14S of the backing 14. The bonding apparatus 166 also serves to set the fixative material and to bond the moisture blocking material to the backing.

Those skilled in the art, having the benefit of the teachings of the present invention as hereinabove set forth, may impart numerous modifications thereto. For example, although FIGS. 10 and 11 show only one guide bar for forming the underlaps, it is understood that additional guide bars may be utilized. Such modifications are to be construed as lying within the contemplation of the present invention, as defined by the appended claims.

What is claimed is:

1. A stitched yarn surface structure comprising:
a backing having a first and a second surface and a thickness dimension T;
a plurality of rows of face yarn underlaps covering the entire first surface of the backing, the yarn underlaps forming a yarn surface having a height dimension D,
wherein the thickness dimension T is at least twice the height dimension D and not less than two millimeters.

2. The stitched yarn surface structure of claim 1 wherein the face yarn underlaps are held to the backing by a plurality of parallel lines of overstitches extending longitudinally along the backing.

3. The stitched yarn surface structure of claim 2 further comprising a plurality of strands of binder material disposed between the yarn underlaps and the first surface of the backing.

4. The stitched yarn surface structure of claim 3 wherein the strands of binder material extend longitudinally along the backing.

5. The stitched yarn surface structure of claim 3 wherein the strands of binder material extend transversely across the backing.

6. The stitched yarn surface structure of claim 2 wherein each overstitch is formed from a stitching thread comprising a composite of a low-melting temperature binder material and a higher melting temperature material.

7. The stitched yarn surface structure of claim 1 further comprising a sheet of material disposed between the yarn underlaps and the first surface of the backing.

8. The stitched yarn surface structure of claim 7 wherein the sheet of material disposed between the yarn underlaps and the first surface of the backing is made from a binder material.

9. The stitched yarn surface structure of claim 7 wherein the sheet of material disposed between the yarn underlaps and the first surface of the backing is made from a moisture blocking material.

10. The stitched yarn surface structure of claim 1 further comprising a sheet of moisture blocking material disposed adjacent to the second surface of the backing.

11. The stitched yarn surface structure of claim 1 wherein the backing comprises at least two layers of dissimilar material.

12. The stitched yarn surface structure of claim 11 wherein one of the layers of the backing comprises is made of a soft, cushioning material.

13. The stitched yarn surface structure of claim 12 wherein the layer of the soft, cushioning material is disposed adjacent to the yarn underlaps.

14. The stitched yarn surface structure of claim 2 further comprising a plurality of strands of reinforcing material disposed between the yarn underlaps and the first surface of the backing.

15. The stitched yarn surface structure of claim 14 wherein the strands of reinforcing material extend longitudinally along the backing.

16. The stitched yarn surface structure of claim 14 wherein the strands of reinforcing material extend transversely across the backing.

17. The stitched yarn surface structure of claim 1 further comprising a plurality of strands of reinforcing material disposed adjacent to the second surface of the backing, the strands of reinforcing material extend transversely across the backing.

18. The stitched yarn surface structure of claim 2 wherein, along a predetermined transverse cross section of the yarn surface structure, the thickness dimension T of the backing at a point substantially midway between a pair of overstitches in transversely adjacent lines of overstitches is at least ten percent (10%) greater than the thickness dimension T′ of the backing in the vicinity of each of the pair of overstitches.

19. The stitched yarn surface structure of claim 2 wherein, along a predetermined transverse cross section of the yarn surface structure,
the backing has a thickness dimension T at a point substantially midway between a pair of overstitches in transversely adjacent lines of overstitches, and
the backing has a thickness dimension T′ in the vicinity of the first one of the pair of overstitches,
the backing has a thickness dimension T″ in the vicinity of the second one of the pair of overstitches,
the thickness dimension T′ varies by at least ten percent (10%) from the thickness dimension T″.

20. The stitched yarn surface structure of claim 2 wherein, along a predetermined longitudinally extending line of overstitches,
the thickness dimension T′ of the backing in the vicinity of a first overstitch in the longitudinal line of overstitches varies by at least ten percent (10%) from the thickness dimension T″ the vicinity of an adjacent overstitch in the same longitudinal line of overstitches.

21. The stitched yarn surface structure of claim 1
wherein the yarns forming the underlaps are stitched into the backing, and
wherein, along a predetermined transverse cross section of the yarn surface structure, the thickness dimension T of the backing at a point substantially midway between a pair of stitches in transversely adjacent lines of stitches is at least ten percent (10%) greater than the thickness dimension T′ of the backing in the vicinity of each of the pair of stitches.

22. The stitched yarn surface structure of claim 1 further comprising:
a flexible layer of fixative material disposed over the face yarn underlaps.

23. The stitched yarn surface structure of claim 1 further comprising:
a liquid coating of a moisture blocking material disposed over the second surface of the backing.

24. The stitched yarn surface structure of claim 1 further comprising:
a liquid coating of a binder material disposed over the first surface of the backing.

25. A process for forming a stitched yarn surface structure comprising the step of:
forming a plurality of rows of face yarn underlaps on a first surface of a backing thereby to form a yarn surface covering the entire surface of the backing, the backing having a thickness dimension T, the yarn surface having a height dimension D, wherein the thickness dimension T is at least twice the height dimension D and not less than two millimeters.

26. The process of claim 25 further comprising the steps of:
applying a binder material to the yarn surface structure,
activating the binder material to hold the yarn underlaps to the surface of the backing.

27. The process of claim 26 wherein the binder application step comprises the step of:
applying a liquid binder material to the first surface of the backing prior to forming the yarn underlaps.

28. The process of claim 26 wherein the binder application step comprises the step of:
applying a sheet of binder material to the first surface of the backing prior to forming the yarn underlaps.

29. The process of claim 25 further comprising the steps of:
applying a liquid fixative material to the face yarn underlaps; and thereafter
curing the fixative material to form a flexible layer over the face yarn underlaps.

30. The process of claim 25 further comprising the step of:
applying a liquid impervious material to the second surface of the backing.
